(19) United States
(12) Patent Application Publication
(10) Pub. No.: US 2022/0306334 A1
(43) Pub. Date: Sep. 29, 2022

(54) TRAY WITH REINFORCED CORNERS

(71) Applicant: WestRock Shared Services, LLC, Atlanta, GA (US)

(72) Inventor: Kenneth C. SMITH, Marietta, GA (US)

(21) Appl. No.: 17/701,783

(22) Filed: Mar. 23, 2022

Related U.S. Application Data
(60) Provisional application No. 63/164,601, filed on Mar. 23, 2021.

(51) Int. Cl. B65D 5/00; B65D 5/20; B65D 5/22; B65D 5/44; B31B 50/81

(52) U.S. Cl. CPC B65D 5/0035; B65D 5/2033; B65D 5/22; B65D 5/443; B31B 50/81; B31B 2120/102

(57) ABSTRACT

A blank of sheet material for forming a polygonal container, the blank including, a bottom panel, two opposing end panels, each end panel extending from an end edge of the bottom panel, two opposing outer side panels, each outer side panel extending from a side edge of the bottom panel, and an inner side panel extending from each top edge of one outer side panel of the two outer side panels and an outer side panel extending from each top edge of the one of the inner side panels, wherein each inner side panel includes a central portion, a corner portion extending from each side of the central portion, and an inner end portion extending from a side of each of the corner portions.

### CROSS-REFERENCE TO RELATED APPLICATIONS

This application claims priority to and the benefit of U.S. Provisional Patent Application No. 63/164,601, filed Mar. 23, 2021, the entire content of which is incorporated herein by reference.

### BACKGROUND OF THE INVENTION

The embodiments described herein relate generally to blanks for forming polygonal containers and, more particularly, to blanks for forming polygonal containers with reinforced corner, end, and side walls.

Containers are frequently utilized to store and aid in transporting products. These containers can be square, hexagonal, or octagonal. The shape of the container can provide additional strength to the container. For example, octagonal-shaped containers provide greater resistance to bulge over conventional rectangular, square or even hexagonal-shaped containers. An octagonal-shaped container may also provide increased stacking strength.

In at least some known cases, a blank of sheet material is used to form a container for transporting a product. More specifically, these known containers are formed by a machine that folds a plurality of panels along fold lines and secures these panels with an adhesive. Such containers may have certain strength requirements for transporting products. These strength requirements may include a stacking strength requirement such that the containers can be stacked on one another during transport without collapsing. To meet these strength requirements, at least some known containers include reinforced corners or side walls for providing additional strength including stacking strength. In at least some known embodiments, additional panels may be placed in a face-to-face relationship with another corner panel or side wall. However, at the same time display and shelf spacing is a premium. At the same time clients and customers are also trying to squeeze as much product into each display as possible, therefor maximizing inner display surface area with the same floorplan, while maintaining the same strength is very important.

### SUMMARY OF THE INVENTION

In one aspect, a blank for forming a reinforced container is provided. The blank includes a bottom panel, two opposing end panels, each end panel extending from an end edge of the bottom panel, two opposing outer side panels, each outer side panel extending from a side edge of the bottom panel, and an inner side panel extending from each top edge of one outer side panel of the two outer side panels and an outer side panel extending from each top edge of the one of the inner side panels, wherein each inner side panel includes a central portion, a corner portion extending from each side of the central portion, and an inner end portion extending from a side of each of the corner portions.

In another aspect blank of sheet material for forming a polygonal container includes a bottom panel, two opposing end panels, each end panel extending from an end edge of the bottom panel, two opposing outer side panels, each outer side panel extending from a side edge of the bottom panel, an inner side panel extending from each top edge of one outer side panel of the two outer side panels and a second inner side panel extending from each top edge of one of the inner side panels, wherein each inner side panel comprises, a central portion, a corner portion extending from each side of the central portion, an inner end portion extending from a side of each of the corner portions.

In another aspect a method of forming a container from a blank of sheet material includes rotating outer side panels towards a bottom panel such that the outer side panels are substantially perpendicular to the bottom panel, rotating inner side panels towards the bottom panel such that the inner side panels are substantially parallel to the outer side panels, wherein central portions of each inner side panel and the outer side panels form a pair of opposing side walls, rotating the corner panels and rotating the corner portions of the inner side panels that each inner end panel is in a face-to-face relationship with a respective inner end portion to form an inner end assembly and rotating the end panels toward the bottom panel such that each end panel is substantially perpendicular to the bottom panel and positioned adjacent a pair of the inner end assemblies to facilitate forming one of a pair of opposing end walls.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a top plan view of an exemplary blank of sheet material for forming a container.

FIG. 2 is a perspective view of an exemplary container formed from the blank shown in FIG. 1.

FIG. 3 is a perspective view of a stack of containers shown in FIG. 2.

FIG. 4 is a top plan view of an embodiment of an alternative blank of sheet material for forming a container.

FIG. 5 is a perspective view of an exemplary container formed from the blank shown in FIG. 4.

FIG. 6 is a top plan view of another embodiment of an alternative blank of sheet material for forming a container.

FIG. 7 is a perspective view of an exemplary container formed from the blank shown in FIG. 6.

FIG. 8 is a top plan view of another embodiment of an alternative blank of sheet material for forming a container.

FIG. 9 is a perspective view of an exemplary container formed from the blank shown in FIG. 8.

FIG. 10 is a top plan view of another embodiment of an alternative blank of sheet material for forming a container.

FIG. 11 is a perspective view of an exemplary container formed from the blank shown in FIG. 10.

FIG. 12 is a top plan view of another embodiment of an alternative blank of sheet material for forming a container.

FIG. 13 is a perspective view of an exemplary container formed from the blank shown in FIG. 12.

### DETAILED DESCRIPTION

The embodiments described herein provide a stackable, reinforced container formed from a single sheet of material and a method for constructing the container. The container is sometimes referred to as a reinforced mitered tray or a reinforced eight-sided container. The container may be constructed from a blank of sheet material using at least one machine.

In one embodiment, the blanks are fabricated from a cardboard material. The blanks, however, may be fabricated using any suitable material, and therefore are not limited to a specific type of material. In alternative embodiments, the blanks are fabricated using cardboard, plastic, fiberboard, paperboard, foam-board, corrugated paper, and/or any suitable material known to those skilled in the art and guided by the teachings herein provided. The container may have any suitable size, shape, and/or configuration, whether such sizes, shapes, and/or configurations are described and/or illustrated herein. Further, different embodiments described here can vary in size and/or dimensions although similar labels are used for each embodiment. For example, although a depth is labeled similarly throughout the description, each embodiment can have varying depths.

In an example embodiment, the container includes at least one marking thereon including, without limitation, indicia that communicates the product stored in the tray, a manufacturer of the product, and/or a seller of the product. For example, the marking may include printed text that indicates a product's name and briefly describes the product, logos and/or trademarks that indicate a manufacturer and/or seller of the product, and/or designs and/or ornamentation that attract attention. “Printing,” “printed,” and/or any other form of “print” as used herein may include, but is not limited to including, ink jet printing, laser printing, screen printing, giclée, pen and ink, painting, offset lithography, flexography, relief print, rotogravure, dye transfer, and/or any suitable printing technique known to those skilled in the art and guided by the teachings herein provided. In another embodiment, the container is void of markings, such as, without limitation, indicia that communicates the product, a manufacturer of the product and/or a seller of the product.

The following detailed description illustrates the disclosure by way of example and not by way of limitation. The description clearly enables one skilled in the art to make and use an exemplary container, describes several embodiments, adaptations, variations, alternatives, and use of the blanks and/or containers, including what is presently believed to be the best mode of carrying out the disclosure.

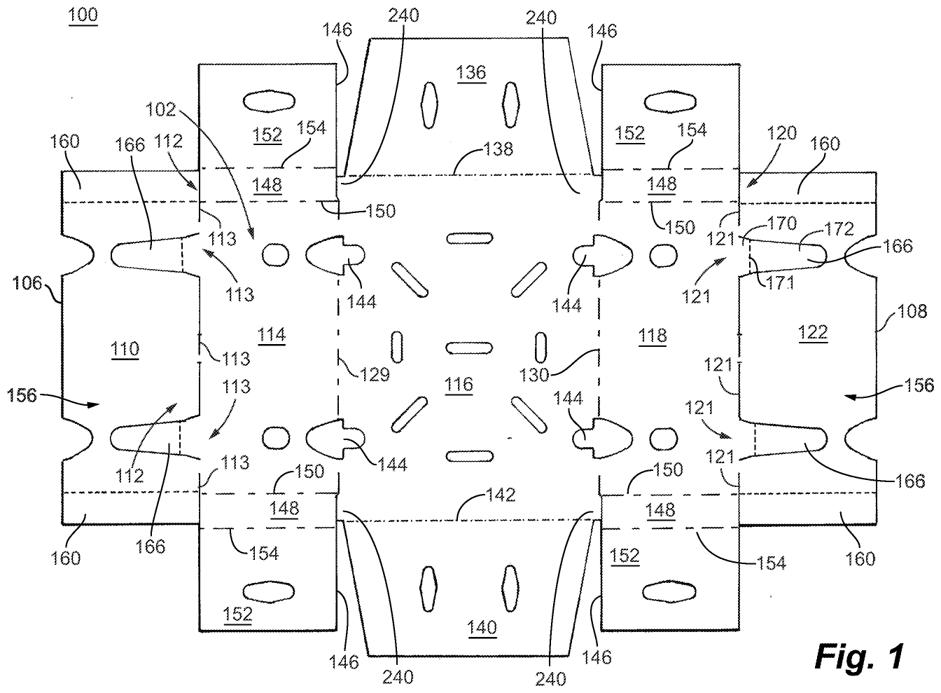

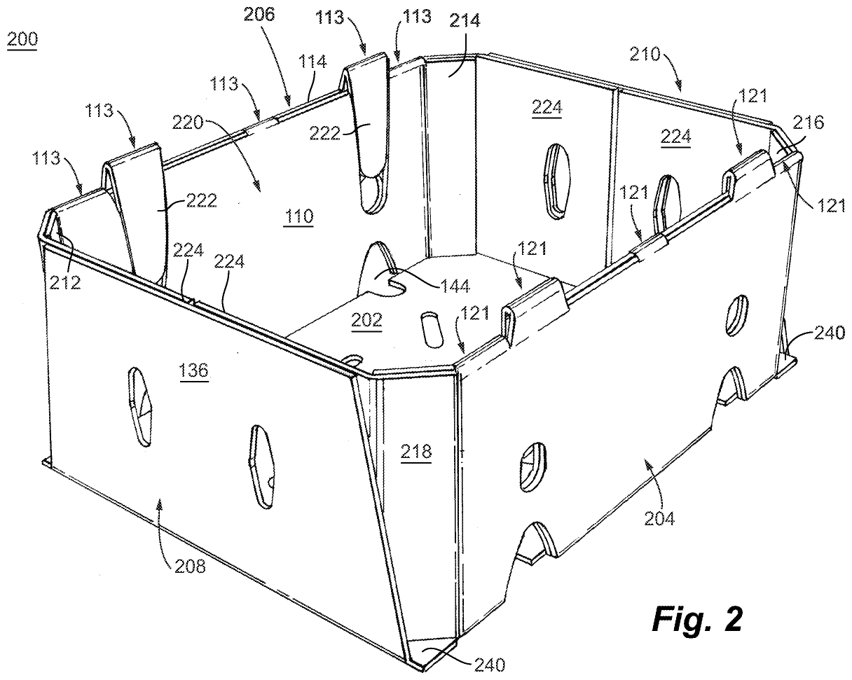

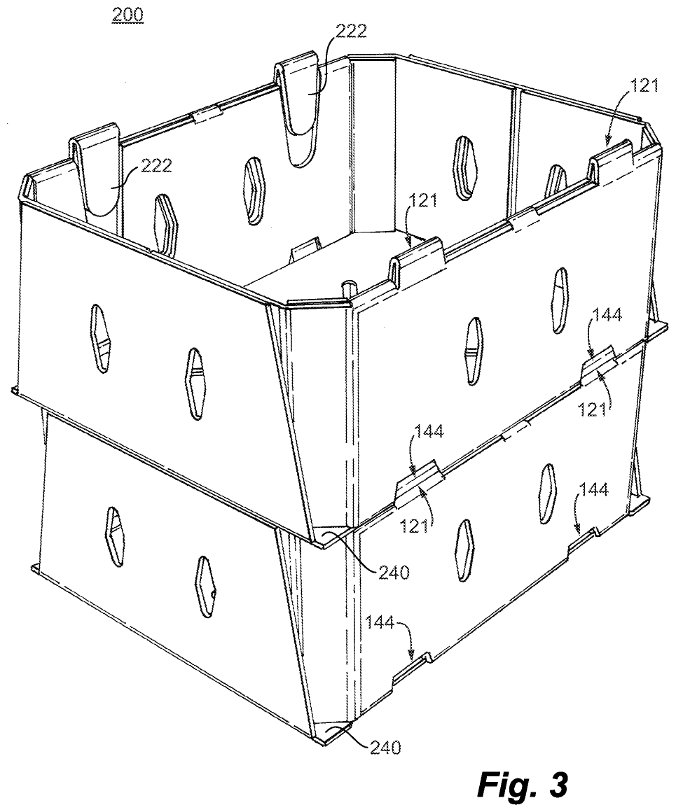

Referring now to the drawings, FIG. 1 is a top plan view of an exemplary blank 100 of sheet material for forming a container 200 (shown in FIGS. 2 and 3). Blank 100 has a first or interior surface 102 and an opposing second or exterior surface 104 (e.g., the underside of 102 in FIG. 1). Further, blank 100 defines a first edge 106 and an opposing second edge 108. In one embodiment, blank 100 includes, in series from first edge 106 to second edge 108, a first inner side panel 110, a first rollover panel 112, a first outer side panel 114, a bottom panel 116, a second outer side panel 118, a second rollover panel 120, and a second inner side panel 122 coupled together. The first rollover panel 112 is defined by first inner side panel 110 and rollover couplings 113 coupling first inner side panel 110 to first outer side panel 114. The second rollover panel 120 is defined by second inner side panel 122 and rollover couplings 121 coupling first inner side panel 110 to first outer side panel 114. Rollover couplings 113, 121 can be more clearly observed in FIG. 2. Rollover panels 112 and 120 allow for a “true” or “full” rollover.

The first outer side panel 114 extends from bottom panel 116 at a side edge 129 and the second outer side panel 118 extends from bottom panel 116 at a second side edge 130. A first end panel 136 extends from a first end edge 138 of bottom panel 116, and an opposing second end panel 140 extends from a second end edge 142 of bottom panel 116. Slots 144 are configured to receive a tab (e.g., the same or similar to stacking tab 222) from a lower container, as described in more detail below and shown in FIG. 3.

A panel assembly 146 extends from each side edge 150 of each outer side panel 114 and 118. As such, blank 100 includes four panel assemblies 146. Each panel assembly 146 includes a corner panel 148 extending from a respective outer side panel 114 or 118 and an inner end panel 152 extending from a respective corner panel 148. Inner end panel 152 is perpendicular to an end portion 160 of each of the first inner side panel 110 and second inner side panel 122.

Each inner side panel 110 and 122 includes a central portion 156 and a pair of inner end portions 160, where inner end portions 160 extend from each side of each central portions 156 at respective fold or perforation lines. The inner end portions 160 may be offset from corner panels 148 to avoid interference from inner end portions 160 when constructing the container. Specifically, the fold or perforations joining the inner end portions 160 to central portions 156 may be offset from the fold lines 150, joining corner panels to the outer side panels 114, 118, or the outer edges of inner end portions 160 may be offset from the fold lines 154 joining the inner end panels 152 to the corner panels 148. In certain embodiments, portions 156, and 160 can be continuous portions of material not interrupted by any fold lines.

When in the formed container, rollover panel 112 or 120 lays along the interior surfaces 102 of the outer side panels 114, 118, extending between each corner panel 148 and between each inner end panel 152, where each inner end portion 160 is substantially aligned with and interfaces with each corner panel 148. A pair of tabs 166 is defined along each rollover panel 112 and 120, forming at least a portion of rollover couplings 113, 121. Each stacking tab 166 can be defined by two portions, a first portion 170 and a second portion 172, where the rollover coupling 113, 121 defines a fold line 171 between the first portion 170 and second portion 172. In the exemplary embodiment, each tab 166 is aligned with a slot 144 on a bottom panel of a corresponding container 200.

FIG. 2 is a perspective view of an exemplary container 200 formed from blank 100 (shown in FIG. 1). Container 200 includes a bottom wall 202, a first side wall 204, a second side wall 206, a first end wall 208, a second end wall 210, and four corner walls 212, 214, 216, and 218 defining a cavity 220. Slots 144 are defined at least in bottom wall 202.

Referring to FIGS. 1 and 2, to form container 200 from blank 100, rollover panel 112 (e.g., first inner side panel 110) is rotated toward interior surface 102 of outer side panel 114 along rollover couplings 113, and rollover panel 120 (e.g., second inner side panel 122) is rotated toward interior surface 102 of outer side panel 118 along rollover couplings 121, until inner side panel 110 is substantially parallel to outer side panel 114 and until inner side panel 122 is substantially parallel to outer side panel 118. At least interior surfaces 102 of central portions 156 of inner side panels 110 and 122 are interface with interior surface 102 of a respective outer side panel 114 or 118 via rollover couplings 113, 121 respectively. First outer side panel 114 and central portion 156 of first inner side panel 110 define first side wall 204, and second outer side panel 118 and central portion 156 of second inner side panel 122 define second side wall 206.

Second portion 172 of each tab 166 is rotated inward toward a respective first portion 170, and interior surface 102 of second portions 172 are interface with interior surface 102 of first portions 170 to form a plurality of stacking tabs 222 extending upward from each side wall 204 and 206.

Each corner panel 148 is in face-to-face relationship with a respective a respective inner end portion 160, and each inner end panel 152 is in a face to face relationship with end panels 136, 140. Each corner panel 148 is rotated toward an adjacent side wall 204 or 206 and each inner end panel 152 is rotated toward an adjacent corner wall 212, 214, 216, or 218. As such, each inner end portion 160 can rotate toward an adjacent corner wall 212, 214, 216, or 218. Each side wall 204 and 206 is rotated toward interior surface 102 of bottom wall 202 defined by bottom panel 116. More specifically, side walls 204 and 206 are rotated to be substantially perpendicular to bottom wall 202. As side walls 204 and 206 are rotated, corner walls 212, 214, 216, and 218 and inner end assemblies 224 rotate toward bottom wall 202 to be substantially perpendicular to bottom wall 202.

First end panel 136 is rotated toward bottom wall 202, and second end panel 140 is rotated toward bottom wall 202. A pair of inner end assemblies 224 adjacent to first end panel 136 is coupled to interior surface 102 of first end panel 136 to form first end wall 208. Similarly, a pair of inner end assemblies 224 adjacent to second end panel 140 is coupled to interior surface 102 of second end panel 140 to form second end wall 210. First end panel 136 and the second end panel 140 are joined to the bottom panel 116 such that an outer edge of the first and second end panels 136, 140 meet the bottom panel at an obtuse angle, where the joining portion of the bottom panel is parallel to an axis of the blank. This allows for a portion 240 to be created when the container 200 is assembled. This portion 240 juts out from the corner wall 218 and allows for better handling when being picked up and transported and stacking of the containers.

FIG. 3 is a perspective view of a stack of containers 200. When containers 200 are stacked, stacking tabs 222 of a lower container 200 are received within slots 144 of an upper container 200.

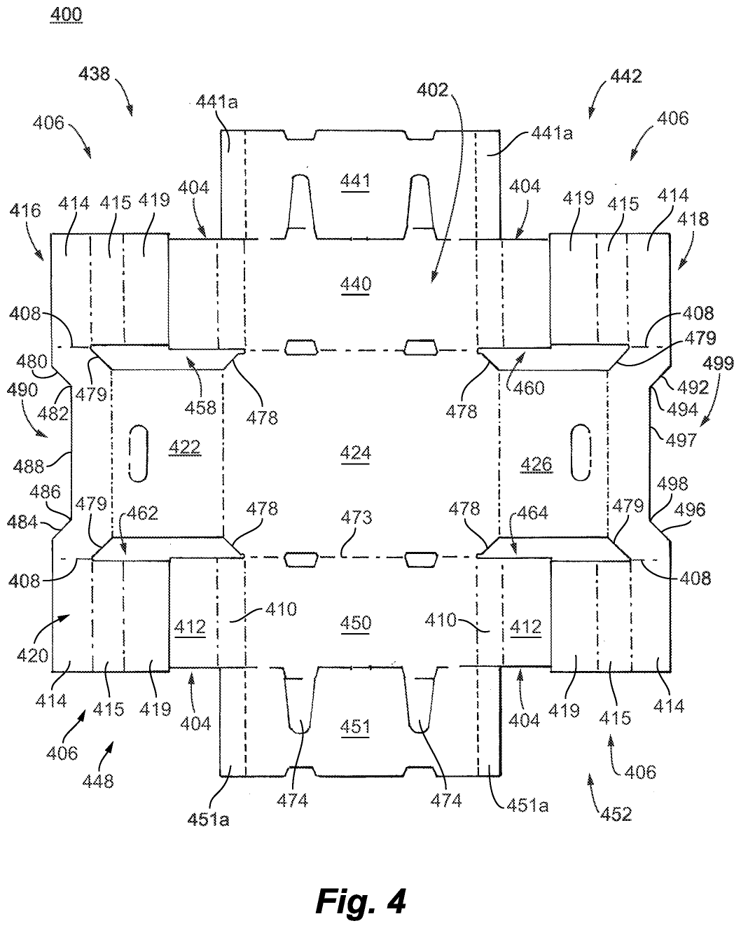

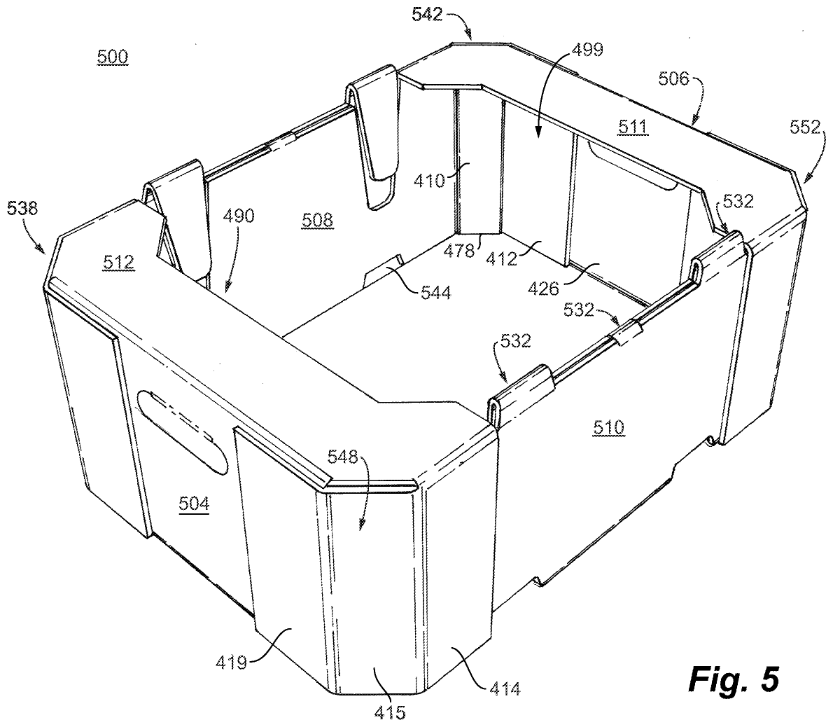

Referring to FIGS. 4 and 5, the blank 400 and container 500 can have the same or similar components and/or can be constructed in the same or similar manner as described above with respect to blank 100 and container 200. For brevity, the description of certain common elements that have been described above may not be repeated with respect to FIGS. 4 and 5. Blank 400 and container 500 are shown having top panels and additional reinforcement assemblies configured to extend along and interface with an exterior surface of the front and rear end panels, the first and second side panels, and the corner panels, further reinforcing the corners of the container, as well as adding a larger surface for stacking. This will be described in more detail below.

Blank 400 has a first or interior surface 402 and an opposing second or exterior surface 403 (e.g., an underside of 402 not shown in FIG. 4). Further, blank 400 defines a leading edge 416 and an opposing trailing edge 418. In one embodiment, blank 400 includes, in series from leading edge 416 to trailing edge 418, a first top panel 420, a first side panel 422, a bottom panel 424, a second side panel 426, and a second top panel 428 coupled together. Blank 400 also includes, in series from leading edge 416 to trailing edge 418, a first reinforcing assembly 438, a front end panel 440 and a second reinforcing assembly 442 coupled together. Moreover, blank 400 includes, in series from leading edge 416 to trailing edge 418, a third reinforcing assembly 448, a rear end panel 450 and a fourth reinforcing assembly 452 coupled together. Still further, in the example embodiment, blank 400 defines a first cutout 458, a second cutout 460, a third cutout 462 and a fourth cutout 464.

First top panel 420 and second top panel 428 are substantially congruent and have a generally trapezoidal shape. More specifically, first top panel 420 includes miter edges 479, an angled edge 480 extending from leading edge 416 toward an apex 482, and an angled edge 484 extending from leading edge 416 toward an apex 486. A free edge 488 extends between angled edge 480 and angled edge 484. Angled edge 480, free edge 488 and angled edge 484 define a cutout 490. Second top panel 428 includes miter edges 479, an angled edge 492 extending from trailing edge 418 toward an apex 494 and an angled edge 496 extending from trailing edge 418 toward an apex 498. A free edge 497 extends between angled edge 492 and angled edge 496. Angled edge 492, free edge 400 and angled edge 496 define a cutout 499.

First reinforcing assembly 438 and second reinforcing assembly 442 extend from side edges of front end panel 440 and from first top panel 420 and second top panel 428, respectively. Third reinforcing assembly 448 and fourth reinforcing assembly 452 extend from side edges of rear end panel 450 and from first top panel 420 and second top panel 428, respectively. Further, each reinforcing panel assembly 438, 442, 448 and 452 are substantially similar and include an inner reinforcing panel assembly 404 and an outer reinforcing panel assembly 406. Moreover, inner reinforcing panel assembly 404 includes a corner panel 410 and a minor panel 412, and outer reinforcing panel assembly 406 includes a first overlap panel 414, a miter panel 415 and a second overlap panel 419. Further, the front end panel 440 is attached to an inner front end panel 441. The inner front end panel 441 folds inward creating a double wall 508 when erected into tray 500. Similarly, rear end panel 450 is attached to inner rear end panel 451 that also folds inward to create a double wall 510 in tray 500. The inner front end panel 441 and inner rear end panel 451 are folded over stacking tabs 532 (e.g., formed from tabs 474) and middle connector 534 (e.g., rollover couplings 513, 521 similar to those described with respect to blank 100). Each of the inner panels 451 and 441 include wings 441a, 451a respectively, which double corner panels 410 in the formed container.

Referring to FIG. 5, to construct container 500 from blank 400, first side panel 422 is rotated toward interior surface 402 of bottom panel 424, front end panel 440 is rotated toward interior surface 402 of bottom panel 424, second side panel 426 is rotated toward interior surface 402 of bottom panel 424 and rear end panel 450 is rotated toward interior surface 402 of bottom panel 424. In the example embodiment, after rotating panels 422, 426, 440 and 450, side panels 422 and 426 are substantially parallel to each other and substantially perpendicular to end panels 440 and 450. Panels 422, 426, 440 and 450 can be rotated by wrapping blank 400 about a mandrel within a machine or by using a tray folder machine.

Once panels 422, 426, 440 and 450 are rotated, first side panel 422 forms a first side wall 504, second side panel 426 forms a second side wall 506, front end panel 440 forms a front wall 508 and rear end panel 450 forms a rear wall 510. Once panels 420 and 428 are rotated, first top panel 420 forms a first top wall 512 and second top panel 428 forms a second top wall 511. To continue construction, first reinforcing assembly 438 is rotated and coupled to first side panel 422 and front end panel 440 and second reinforcing assembly 442 is rotated and coupled to second side panel 426 and front end panel 440. Third reinforcing assembly 448 is rotated and coupled to first side panel 422 and rear end panel 450 and fourth reinforcing assembly 452 is rotated and coupled to second side panel 426 and rear end panel 450.

More specifically, inner assembly 404 of first reinforcing assembly 438 is rotated and coupled to interior surface of first side panel 422, first top panel 420 is rotated toward interior surface 402 of bottom panel 424, and outer assembly 406 of first reinforcing assembly 438 is rotated and coupled to exterior surfaces 403 of first side panel 422 and front end panel 440.

Inner assembly 404 of second reinforcing assembly 442 is rotated and coupled to interior surface 402 of second side panel 426, second top panel 428 is rotated toward interior surface 402 of bottom panel 424, and outer assembly 406 of second reinforcing assembly 442 is rotated and coupled to exterior surfaces 403 of second side panel 426 and front end panel 440. Inner assembly 404 of third reinforcing assembly 448 is rotated and coupled to interior surface 402 of first side panel 422, first top panel 420 is rotated toward interior surface 402 of bottom panel 424, and outer assembly 406 of third reinforcing assembly 448 is rotated and coupled to exterior surfaces 403 of first side panel 422 and rear end panel 450. Inner assembly 404 of fourth reinforcing assembly 452 is rotated and coupled to interior surface of second side panel 426, second top panel 428 is rotated toward interior surface 402 of bottom panel 424, and outer assembly 406 of fourth reinforcing assembly 452 is rotated and coupled to exterior surfaces 403 of second side panel 426 and rear end panel 450.

In the example embodiment, minor panels 412 are adhered to interior surface 402 of first and second side panels 422 and 426 so that corner panels 410 extend diagonally across the corners of the interior of container 500, acting as stacking support structures. In particular, corner panels 410 are folded over to positions perpendicular to bottom panel 424. Then, first overlap panels 414 are folded down along fold line 408 to positions parallel to exterior surfaces 403 of panels 440 and 450. Second overlap panels 419 are then folded along fold line 408 perpendicular to first overlap panels 414 and coupled to exterior surfaces 403 of side panels 422 and 426. Miter panels 415 of each assembly 438, 442, 448 and 452 are coupled to angled edges 478 of bottom panel 424 and/or corner panels 410 to form reinforcing corner assemblies 538, 542, 548, 552. In embodiments, the angled edges 478 connect side panels 422 and 426 to front and rear panels 450 and 440 respectively with a straight and non-angled edges.

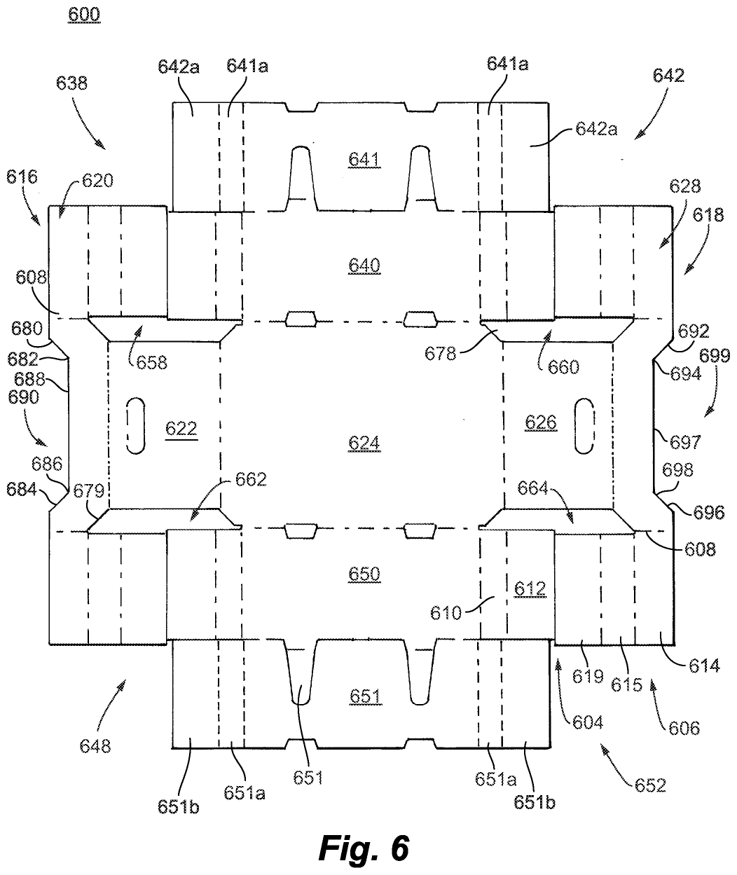

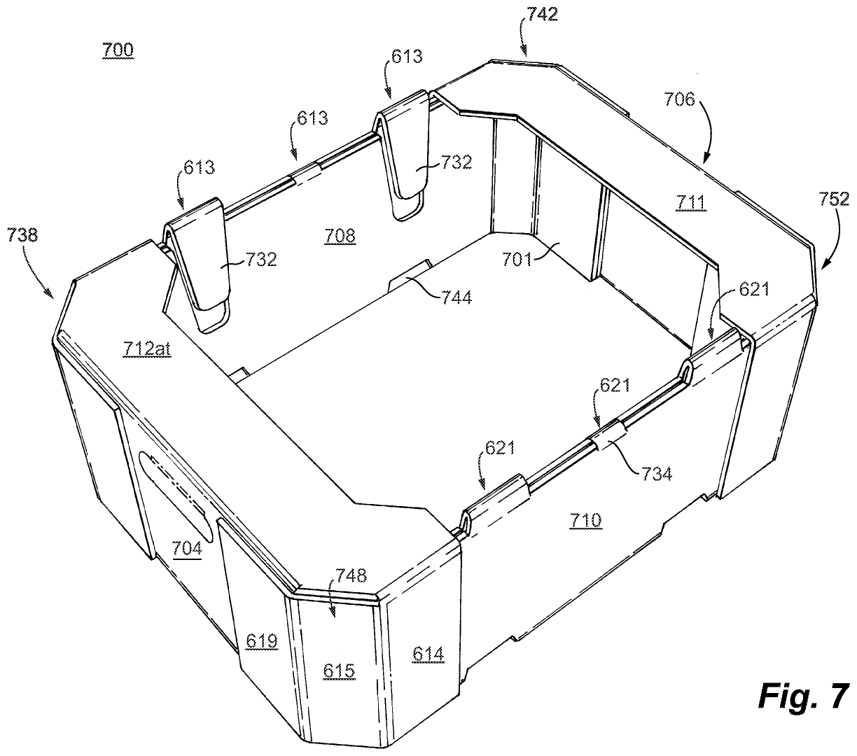

Referring to FIGS. 6 and 7, the blank 600 and container 700 can have the same or similar components and/or can be constructed in the same or similar manner as described above with respect to blank 400 and container 500. For brevity, the description of certain common elements that have been described above may not be repeated with respect to FIGS. 6 and 7, where the blank 600 and container 700 are shown having wings extending front and rear inner end panels configured to interface with the interior surface of the side panels. This will be described in more detail below.

Blank 600 has a first or interior surface 602 and an opposing second or exterior surface 603 (e.g., an underside of interior surface 602 in FIG. 6). Further, blank 600 defines a leading edge 616 and an opposing trailing edge 618. In one embodiment, blank 600 includes, in series from leading edge 616 to trailing edge 618, a first top panel 620, a first side panel 622, a bottom panel 624, a second side panel 626, and a second top panel 628 coupled together. Blank 600 includes, in series from leading edge 616 to trailing edge 618, a first reinforcing assembly 638, a front end panel 640 and a second reinforcing assembly 642 coupled together. Moreover, blank 600 includes, in series from leading edge 616 to trailing edge 618, a third reinforcing assembly 648, a rear end panel 650 and a fourth reinforcing assembly 652 coupled together. Still further, in the example embodiment, blank 600 defines a first cutout 658, a second cutout 660, a third cutout 662 and a fourth cutout 664.

First top panel 620 and second top panel 628 are substantially congruent and have a generally trapezoidal shape. More specifically, first top panel 620 includes miter edges 679, an angled edge 680 extending from leading edge 616 toward an apex 682, and an angled edge 684 extending from leading edge 616 toward an apex 686. A free edge 688 extends between angled edge 680 and angled edge 684. Angled edge 680, free edge 688 and angled edge 684 define a cutout 690. Second top panel 628 includes an angled edge 692 extending from trailing edge 618 toward an apex 694 and an angled edge 696 extending from trailing edge 618 toward an apex 698. A free edge 697 extends between angled edge 692 and angled edge 696. Angled edge 692, free edge 600 and angled edge 696 define a cutout 699.

First reinforcing assembly 638 and second reinforcing assembly 642 extend from side edges of front end panel 640 and from first top panel 620 and second top panel 628, respectively. Third reinforcing assembly 648 and fourth reinforcing assembly 652 extend from side edges of rear end panel 650 and from first top panel 620 and second top panel 628, respectively. Further, each reinforcing panel assembly 638, 642, 648 and 652 are substantially similar and include an inner reinforcing panel assembly 604 and an outer reinforcing panel assembly 606, as shown with respect to reinforcing panel assembly 652. Moreover, inner reinforcing panel assembly 604 includes a corner panel 610 and a minor panel 612, and outer reinforcing panel assembly 606 includes a first overlap panel 614, a miter panel 615, and a second overlap panel 619. Further, the front end panel 640 is attached to an inner front end panel 641. The inner front end panel folds inward creating a double wall 708 when erected into container (or tray) 700. Similarly rear end panel 650 is attached to an inner rear end panel 651 that also folds inward to create a double wall 710 in tray 700. The inner front end panel 641 and the inner rear end panel 651 are folded over tabs 732 and via middle connector 734 (e.g., rollover couplings 613, 621 similar to those described with respect to blank 100). Each of the inner panels 651 and 641 include wings 651a and 651b respectively, which double and reinforce corner assemblies 702 and the adjacent panel 701.

Referring to FIG. 7, to construct container 700 from blank 600, first side panel 622 is rotated toward interior surface 602 of bottom panel 624, front end panel 640 is rotated toward interior surface 602 of bottom panel 624, second side panel 626 is rotated toward interior surface 602 of bottom panel 624 and rear end panel 650 is rotated toward interior surface 602 of bottom panel 624. In the example embodiment, after rotating panels 622, 626, 640 and 650, side panels 622 and 626 are substantially parallel to each other and substantially perpendicular to end panels 640 and 650. Panels 622, 626, 640 and 650 can be rotated by wrapping blank 600 about a mandrel within a machine or by using a tray folder machine.

Once panels 622, 626, 640 and 650 are rotated, first side panel 622 forms a first side wall 704, second side panel 626 forms a second side wall 706, front end panel 640 forms a front wall 708 and rear end panel 650 forms a rear wall 710. Once panels 620 and 628 are rotated, first top panel 620 forms a first top wall 712 and second top panel 628 forms a second top wall 711. To continue construction, first reinforcing assembly 638 is rotated and coupled to first side panel 622 and front end panel 640 and second reinforcing assembly 642 is rotated and coupled to second side panel 626 and front end panel 640. Third reinforcing assembly 648 is rotated and coupled to first side panel 622 and rear end panel 650 and fourth reinforcing assembly 652 is rotated and coupled to second side panel 626 and rear end panel 650.

More specifically, inner assembly 604 of first reinforcing assembly 638 is rotated and coupled to interior surface 602 of first side panel 622, first top panel 620 is rotated toward interior surface 602 of bottom panel 624, and outer assembly 606 of first reinforcing assembly 638 is rotated downward (e.g., along fold line 608) and coupled to exterior surfaces 603 of first side panel 622 and front end panel 640.

Inner assembly 604 of second reinforcing assembly 642 is rotated and coupled to interior surface 602 of second side panel 626, second top panel 628 is rotated toward interior surface 602 of bottom panel 624, and outer assembly 606 of second reinforcing assembly 642 is rotated downward (e.g., along fold line 608) and coupled to exterior surfaces 603 of second side panel 626 and front end panel 640. Inner assembly 604 of third reinforcing assembly 648 is rotated and coupled to interior surface 602 of first side panel 622, first top panel 620 is rotated toward interior surface 602 of bottom panel 624, and outer assembly 606 of third reinforcing assembly 648 is rotated downward (e.g., along fold line 608) and coupled to exterior surfaces 603 of first side panel 622 and rear end panel 650. Inner assembly 604 of fourth reinforcing assembly 652 is rotated and coupled to interior surface 602 of second side panel 626, second top panel 628 is rotated toward interior surface 602 of bottom panel 624, and outer assembly 606 of fourth reinforcing assembly 652 is rotated downward (e.g., along fold line 608) and coupled to exterior surfaces 603 of second side panel 626 and rear end panel 650.

In the example embodiment, minor panels 612 are adhered to interior surface 602 of first and second side panels 622 and 626 so that corner panels 610 extend diagonally across the corners of the interior of container 700, acting as stacking support structures. In particular, corner panels 610 are folded over to positions perpendicular to bottom panel 624. Then, first overlap panels 614 are folded down to positions parallel to exterior surfaces 603 of panels 640 and 650. Second overlap panels 619 are then folded perpendicular to first overlap panels 614 and coupled to exterior surfaces 603 of side panels 622 and 626. Miter panels 615 of each assembly 638, 642, 648 and 652 are coupled to angled edges 678 of bottom panel 624 and/or corner panels 610 to form reinforcing corner assemblies 738, 742, 748, 752. In certain embodiments, the angled edges 678 can connect side panels 622 and 626 to front and rear panels 650 and 640 respectively with a straight and non-angled edges.

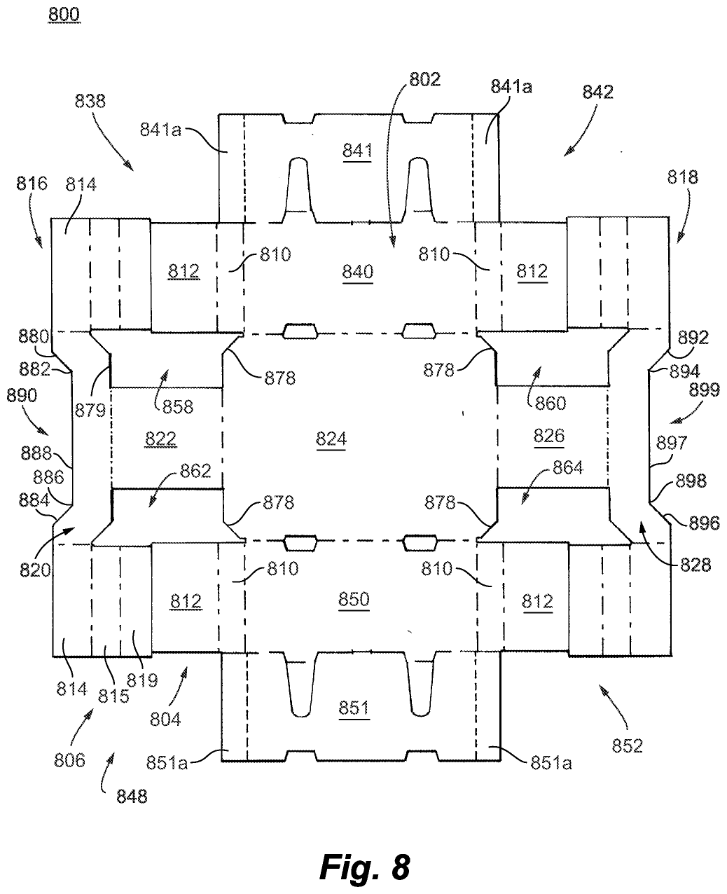

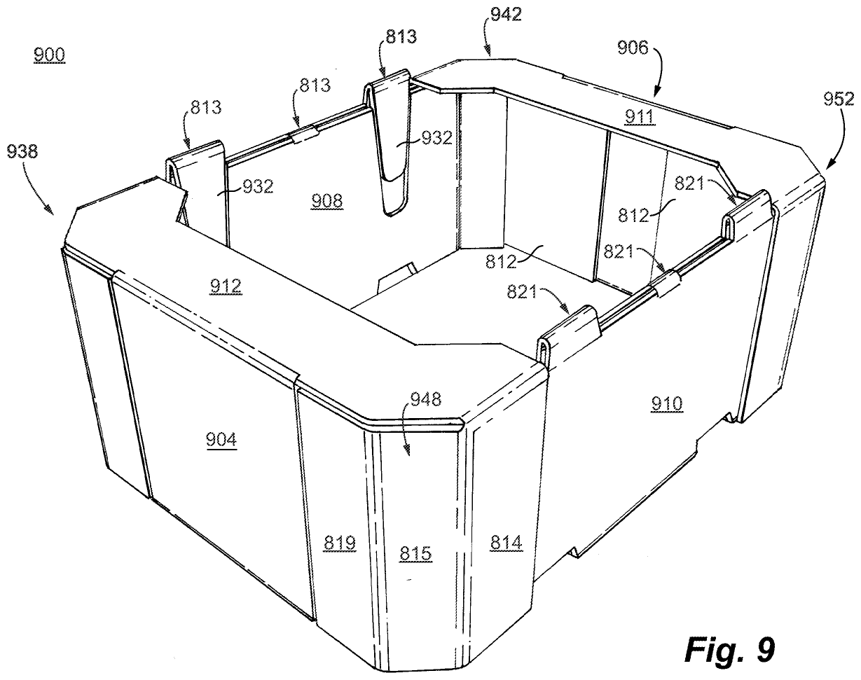

Referring to FIGS. 8 and 9, the blank 800 and container 900 can have the same or similar components and/or can be constructed in the same or similar manner as described above with respect to blank 400 and container 500. For brevity, the description of certain common elements that have been described above may not be repeated with respect to FIGS. 8 and 9, where the blank 800 and container 900 are shown having square first and second side panels, where a portion of the minor panels form a portion of the first and second side panels. This will be described in more detail below.

Blank 800 has a first or interior surface 802 and an opposing second or exterior surface 803 (e.g., an underside of the interior surface 802 as shown in FIG. 8). Further, blank 800 defines a leading edge 816 and an opposing trailing edge 818. In one embodiment, blank 800 includes, in series from leading edge 816 to trailing edge 818, a first top panel 820, a first side panel 822, a bottom panel 824, a second side panel 826, and a second top panel 828 coupled together. Blank 800 includes, in series from leading edge 816 to trailing edge 818, a first reinforcing assembly 838, a front end panel 840 and a second reinforcing assembly 842 coupled together. Moreover, blank 800 includes, in series from leading edge 816 to trailing edge 818, a third reinforcing assembly 848, a rear end panel 850 and a fourth reinforcing assembly 852 coupled together. Still further, in the example embodiment, blank 800 defines a first cutout 858, a second cutout 860, a third cutout 862 and a fourth cutout 864.

First top panel 820 and second top panel 828 are substantially congruent and have a generally trapezoidal shape. More specifically, first top panel 820 includes miter edges 879, an angled edge 880 extending from leading edge 816 toward an apex 882, and an angled edge 884 extending from leading edge 816 toward an apex 886. A free edge 888 extends between angled edge 880 and angled edge 884. Angled edge 880, free edge 888 and angled edge 884 define a cutout 890. Second top panel 828 includes an angled edge 892 extending from trailing edge 818 toward an apex 894 and an angled edge 896 extending from trailing edge 818 toward an apex 898. A free edge 800 extends between angled edge 892 and angled edge 896. Angled edge 892, free edge 897 and angled edge 896 define a cutout 899.

First reinforcing assembly 838 and second reinforcing assembly 842 extend from side edges of front end panel 840 and from first top panel 820 and second top panel 828, respectively. Third reinforcing assembly 848 and fourth reinforcing assembly 852 extend from side edges of rear end panel 850 and from first top panel 820 and second top panel 828, respectively. Further, each reinforcing panel assembly 838, 842, 848 and 852 are substantially similar and include an inner reinforcing panel assembly 804 and an outer reinforcing panel assembly 806, for example as shown with respect to reinforcing panel assembly 848. Moreover, inner reinforcing panel assembly 804 includes a corner panel 810 and a minor panel 812, and outer reinforcing panel assembly 806 includes a first overlap panel 814, a miter panel 818 and a second overlap panel 819. Further, the front end panel 840 is attached to an inner front end panel 841. The inner first top panel folds inward creating a double wall 908 when erected into tray 900. Similarly rear end panel 850 is attached to inner rear end panel 851 that also folds inward to create a double wall 910 in tray 900. The inner front end panel 841 and inner rear end panel 851 are folded over tabs 932 and middle connector 934 (e.g., rollover couplings 813, 821 similar to those described with respect to blank 100). Each of the inner panels 851 and 841 include wings 841a, 841b respectively, which double reinforces corner assemblies 938, 942, 948, 952.

Referring to FIG. 9, to construct container 900 from blank 800, first side panel 822 is rotated toward interior surface 802 of bottom panel 824, front end panel 840 is rotated toward interior surface 802 of bottom panel 824, second side panel 826 is rotated toward interior surface 802 of bottom panel 824 and rear end panel 850 is rotated toward interior surface 802 of bottom panel 824. In the example embodiment, after rotating panels 822, 826, 840 and 850, side panels 822 and 826 are substantially parallel to each other and substantially perpendicular to end panels 840 and 850. Panels 822, 826, 840 and 850 can be rotated by wrapping blank 800 about a mandrel within a machine or by using a tray folder machine.

Once panels 822, 826, 840 and 850 are rotated, first side panel 822 forms a first side wall 904, second side panel 826 forms a second side wall 906, front end panel 840 forms a front wall 908 and rear end panel 850 forms a rear wall 910. Once panels 820 and 828 are rotated, first top panel 820 forms a first top wall 912 and second top panel 828 forms a second top wall 911. To continue construction, first reinforcing assembly 838 is rotated and coupled to first side panel 822 and front end panel 840 and second reinforcing assembly 842 is rotated and coupled to second side panel 826 and front end panel 840. Third reinforcing assembly 848 is rotated and coupled to first side panel 822 and rear end panel 850 and fourth reinforcing assembly 852 is rotated and coupled to second side panel 826 and rear end panel 850.

More specifically, inner assembly 804 of first reinforcing assembly 838 is rotated and coupled to interior surface 802 of first side panel 822, first top panel 820 is rotated toward interior surface 802 of bottom panel 824, and outer assembly 806 of first reinforcing assembly 838 is rotated and coupled to exterior surfaces 803 of first side panel 822 and front end panel 840.

Inner assembly 804 of second reinforcing assembly 842 is rotated and coupled to interior surface 802 of second side panel 826, second top panel 828 is rotated toward interior surface 802 of bottom panel 824, and outer assembly 806 of second reinforcing assembly 842 is rotated and coupled to exterior surfaces 803 of second side panel 826 and front end panel 840. Inner assembly 804 of third reinforcing assembly 848 is rotated and coupled to interior surface 802 of first side panel 822, first top panel 820 is rotated toward interior surface 802 of bottom panel 824, and outer assembly 806 of third reinforcing assembly 848 is rotated and coupled to exterior surfaces 803 of first side panel 822 and rear end panel 850. Inner assembly 804 of fourth reinforcing assembly 852 is rotated and coupled to interior surface 802 of second side panel 826, second top panel 828 is rotated toward interior surface 802 of bottom panel 824, and outer assembly 806 of fourth reinforcing assembly 852 is rotated and coupled to exterior surfaces 803 of second side panel 826 and rear end panel 850.

In the example embodiment, minor panels 812 are adhered to interior surface 802 of first and second side panels 822 and 826 so that corner panels 810 extend diagonally across the corners of the interior of container 900, acting as stacking support structures. In particular, corner panels 810 are folded over to positions perpendicular to bottom panel 824. Then, first overlap panels 814 are folded down to positions parallel to exterior surfaces 803 of panels 840 and 850. Second overlap panels 819 are then folded perpendicular to first overlap panels 814 and coupled to exterior surfaces 803 of side panels 822 and 826. Miter panels 815 of each assembly 838, 842, 848 and 852 are coupled to angled edges 878 of bottom panel 824 and/or corner panels 810 to form reinforcing corner assemblies 902. In certain embodiments, the angled edges 878 can connect side panels 822 and 826 to front and rear panels 850 and 840 respectively with straight edges having a single kink therein. Further, the side panels 822 and 826 are square in this embodiment.

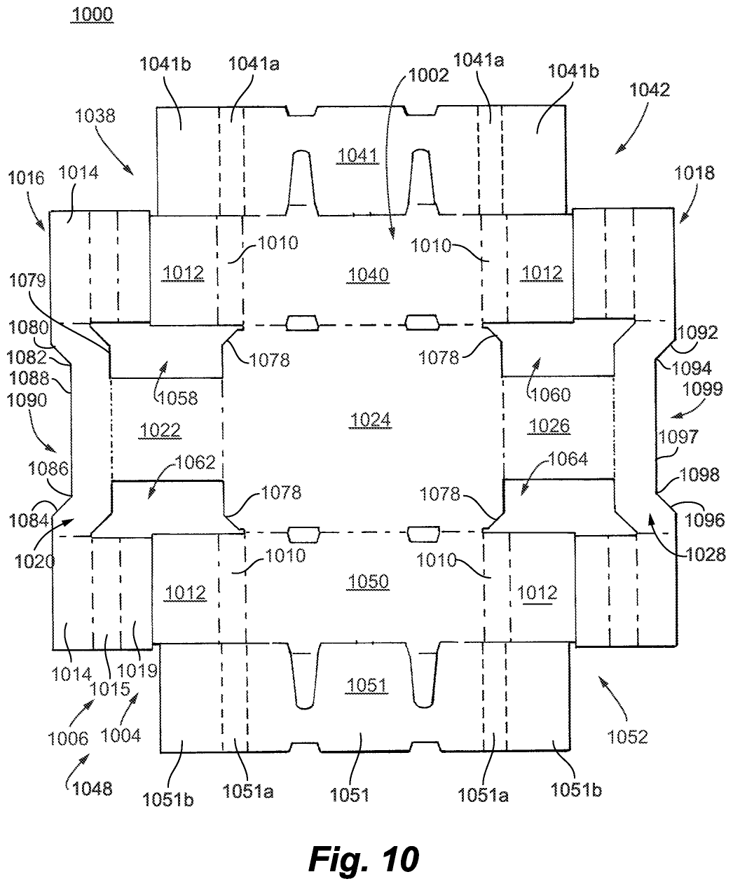

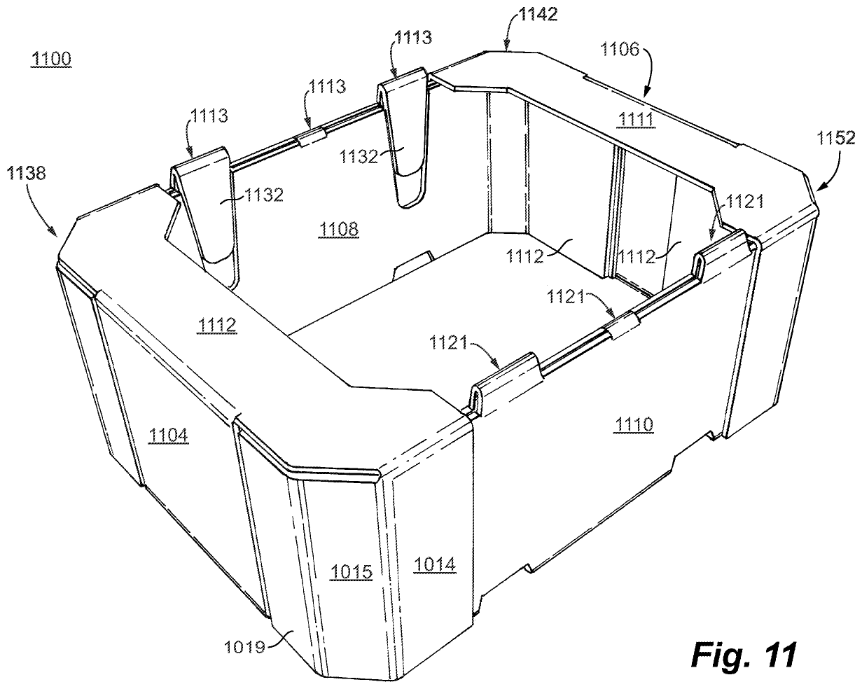

Referring to FIGS. 10 and 11, the blank 1000 and container 1100 can have the same or similar components and/or can be constructed in the same or similar manner as described above with respect to blank 600 and container 700, and blank 800 and container 900. For brevity, the description of certain common elements that have been described above may not be repeated with respect to FIGS. 10 and 11, where the blank 1000 and container 1100 are shown having square first and second side panels, where a portion of the minor panels form a portion of the first and second side panels, and the front and rear end panels also include wings configured to interface with the exterior surface of the first and second side panels. This will be described in more detail below.

Blank 1000 has a first or interior surface 1002 and an opposing second or exterior surface 1003 (e.g., an underside of interior surface 1002 as shown in FIG. 10). Further, blank 1000 defines a leading edge 1016 and an opposing trailing edge 1018. In one embodiment, blank 1000 includes, in series from leading edge 1016 to trailing edge 1018, a first top panel 1020, a first side panel 1022, a bottom panel 1024, a second side panel 1026, and a second top panel 1028 coupled together. Blank 1000 includes, in series from leading edge 1016 to trailing edge 1018, a first reinforcing assembly 1038, a front end panel 1040 and a second reinforcing assembly 1042 coupled together. Moreover, blank 1000 includes, in series from leading edge 1016 to trailing edge 1018, a third reinforcing assembly 1048, a rear end panel 1050 and a fourth reinforcing assembly 1052 coupled together. Still further, in the example embodiment, blank 1000 defines a first cutout 1058, a second cutout 1060, a third cutout 1062 and a fourth cutout 1064.

First top panel 1020 and second top panel 1028 are substantially congruent and have a generally trapezoidal shape. More specifically, first top panel 1020 includes miter edges 1079, an angled edge 1080 extending from leading edge 1016 toward an apex 1082, and an angled edge 1084 extending from leading edge 1016 toward an apex 1086. A free edge 1088 extends between angled edge 1080 and angled edge 1084. Angled edge 1080, free edge 1088 and angled edge 1084 define a cutout 1090. Second top panel 1028 includes an angled edge 1092 extending from trailing edge 1018 toward an apex 1094 and an angled edge 1096 extending from trailing edge 1018 toward an apex 1098. A free edge 1000 extends between angled edge 1092 and angled edge 1096. Angled edge 1092, free edge 1000 and angled edge 1096 define a cutout 1002.

First reinforcing assembly 1038 and second reinforcing assembly 1042 extend from side edges of front end panel 1040 and from first top panel 1020 and second top panel 1028, respectively. Third reinforcing assembly 1048 and fourth reinforcing assembly 1052 extend from side edges of rear end panel 1050 and from first top panel 1020 and second top panel 1028, respectively. Further, each reinforcing panel assembly 1038, 1042, 1048 and 1052 are substantially similar and include an inner reinforcing panel assembly 1004 and an outer reinforcing panel assembly 1006. Moreover, inner reinforcing panel assembly 1004 includes a corner panel 1010 and a minor panel 1012, and outer reinforcing panel assembly 1006 includes a first overlap panel 1014, a miter panel 1015 and a second overlap panel 1098. Further, the first top panel 1040 is attached to an inner first top panel 1041. The inner first top panel folds inward creating a double wall 1108 when erected into tray 1100. Similarly rear end panel 1050 is attached to inner rear end panel 1051 that also folds inward to create a double wall 1110 in tray 1100. The inner front end panel 1041 and inner rear end panel 1051 are folded over tabs 1132 and middle connector 1134 (e.g., rollover couplings 1013, 1021 similar to those described with respect to blank 100). Each of the inner panels 1051 and 1041 include wings 1041a, 1041b, 1051a, 1051b respectively, which doubles and reinforces corner assemblies 1102 and the adjacent panel 1101.

Referring to FIG. 11, to construct container 1100 from blank 1010, first side panel 1022 is rotated toward interior surface 1002 of bottom panel 1024, front end panel 1040 is rotated toward interior surface 1002 of bottom panel 1024, second side panel 1026 is rotated toward interior surface 1002 of bottom panel 1024 and rear end panel 1050 is rotated toward interior surface 1002 of bottom panel 1024. In the example embodiment, after rotating panels 1022, 1026, 1040 and 1050, side panels 1022 and 1026 are substantially parallel to each other and substantially perpendicular to end panels 1040 and 1050. Panels 1022, 1026, 1040 and 1050 can be rotated by wrapping blank 1000 about a mandrel within a machine or by using a tray folder machine.

Once panels 1022, 1026, 1040 and 1050 are rotated, first side panel 1022 forms a first side wall 1104, second side panel 1026 forms a second side wall 1106, front end panel 1040 forms a front wall 1108 and rear end panel 1050 forms a rear wall 1110. Once panels 1020 and 1028 are rotated, first top panel 1020 forms a first top wall 1112 and second top panel 1028 forms a second top wall 1111. To continue construction, first reinforcing assembly 1038 is rotated and coupled to first side panel 1022 and front end panel 1040 and second reinforcing assembly 1042 is rotated and coupled to second side panel 1026 and front end panel 1040. Third reinforcing assembly 1048 is rotated and coupled to first side panel 1022 and rear end panel 1050 and fourth reinforcing assembly 1052 is rotated and coupled to second side panel 1026 and rear end panel 1050.

More specifically, inner assembly 1004 of first reinforcing assembly 1038 is rotated and coupled to interior surface 1002 of first side panel 1022, first top panel 1020 is rotated toward interior surface 1002 of bottom panel 1024, and outer assembly 1006 of first reinforcing assembly 1038 is rotated and coupled to exterior surfaces 1003 of first side panel 1022 and front end panel 1040.

Inner assembly 1004 of second reinforcing assembly 1042 is rotated and coupled to interior surface 1002 of second side panel 1026, second top panel 1028 is rotated toward interior surface 1002 of bottom panel 1024, and outer assembly 1006 of second reinforcing assembly 1042 is rotated and coupled to exterior surfaces 1003 of second side panel 1026 and front end panel 1040. Inner assembly 1004 of third reinforcing assembly 1048 is rotated and coupled to interior surface 1002 of first side panel 1022, first top panel 1020 is rotated toward interior surface 1002 of bottom panel 1024, and outer assembly 1006 of third reinforcing assembly 1048 is rotated and coupled to exterior surfaces 1003 of first side panel 1022 and rear end panel 1050. Inner assembly 1004 of fourth reinforcing assembly 1052 is rotated and coupled to interior surface 1002 of second side panel 1026, second top panel 1028 is rotated toward interior surface 1002 of bottom panel 1024, and outer assembly 1006 of fourth reinforcing assembly 1052 is rotated and coupled to exterior surfaces 1003 of second side panel 1026 and rear end panel 1050.

In the example embodiment, minor panels 1012 are adhered to interior surface 1002 of first and second side panels 1022 and 1026 so that corner panels 1010 extend diagonally across the corners of the interior of container 1100, acting as stacking support structures. In particular, corner panels 1010 are folded over to positions perpendicular to bottom panel 1024. Then, first overlap panels 1014 are folded down to positions parallel to exterior surfaces 1003 of panels 1040 and 1050. Second overlap panels 1018 are then folded perpendicular to first overlap panels 1014 and coupled to exterior surfaces 1003 of side panels 1022 and 1026. Miter panels 1015 of each assembly 1038, 1042, 1048 and 1052 are coupled to angled edges 1078 of bottom panel 1024 and/or corner panels 1010 to form reinforcing corner assemblies 1138, 1142, 1148, 1152. In certain embodiments, the angled edges 1078 can connect side panels 1022 and 1026 to front and rear panels 1050 and 1040 respectively with straight edges having a single kink therein.

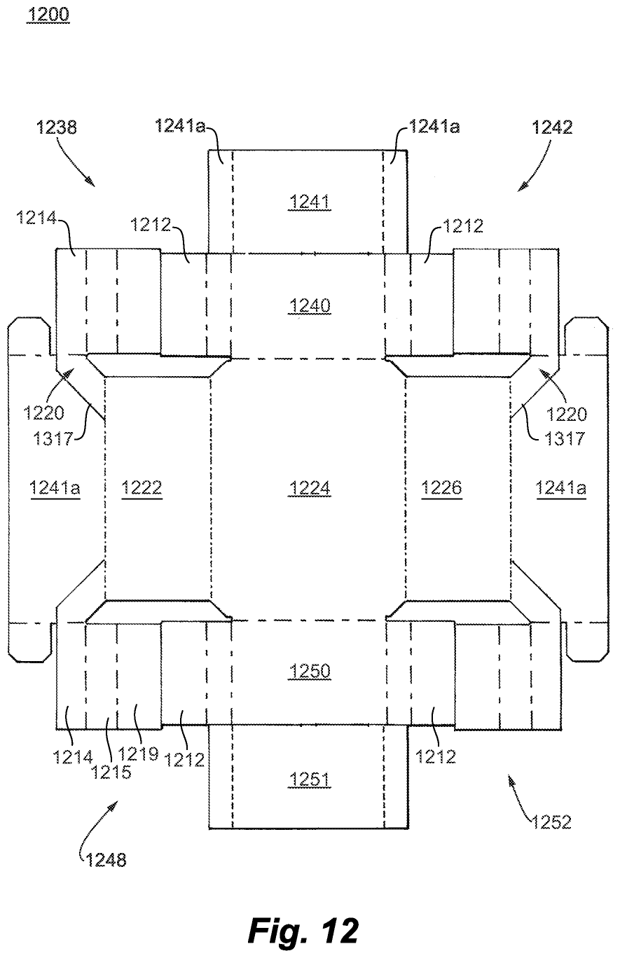

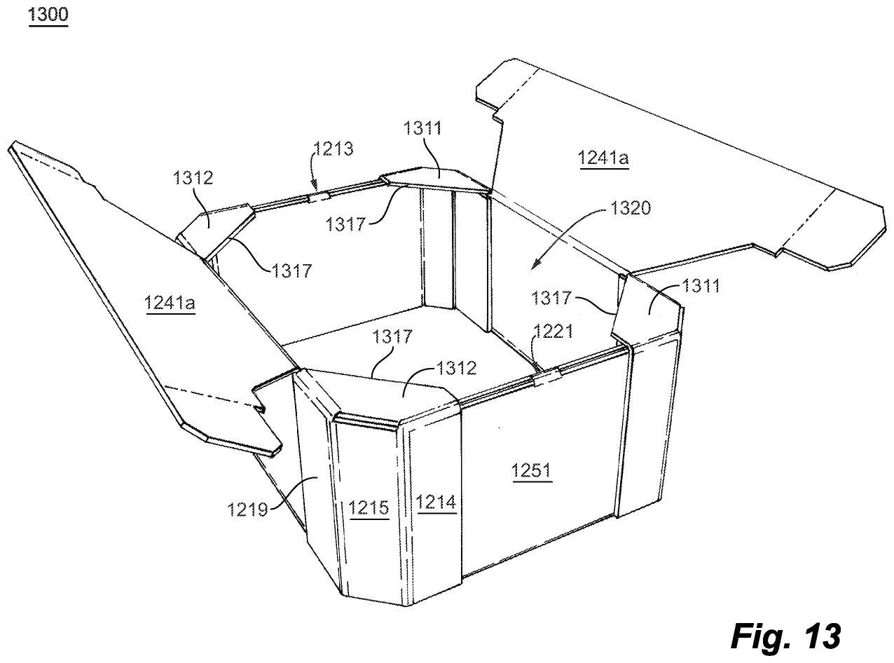

Referring to FIGS. 12 and 13 the blank 1200 and container 1300 can have the same or similar components and/or can be constructed in the same or similar manner as described above with respect to blank 400 and container 500. For brevity, the description of certain common elements that have been described above may not be repeated with respect to FIGS. 12 and 13, where the blank 1200 and container 1300 are shown having top flaps configured to extend and from each of the first and second side panels to full enclose an interior cavity 1320. Additionally, in blank 1200 and container 1300, the top flaps 1241a and side panels 1222, 1226 can be defined in a long side of the container 1300, while the end flaps 1240, 1250 and rollovers 1213, 1221 can be defined in a short side of the container 1300.

This embodiment further includes top flaps 1241a which are attached to the panels 1220 respectively and fold towards each other in an erected form in FIG. 13 to close the top of the container 1300. Top flaps 1241a can be formed by including cuts 1317 in top panels 1220, 1228 so that when the container 1300 is formed, the reinforcement assemblies (e.g., as shown with respect to reinforcement assembly 1348, remain intact to enclose a portion of the cavity 1320 (including portions of top panel 1220), to form a portion of a first top wall 1312, and a portion of second top wall 1311, when the top flaps 1241a are open.

Exemplary embodiments of reinforced polygonal containers and blanks for making the same are described above in detail. The containers and blanks are not limited to the specific embodiments described herein, but rather, components of the blanks and/or the containers may be utilized independently and separately from other components described herein.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A blank of sheet material for forming a polygonal container, the blank comprising:
a bottom panel;
two opposing end panels, each end panel extending from an end edge of the bottom panel;
two opposing outer side panels, each outer side panel extending from a side edge of the bottom panel; and
an inner side panel extending from each top edge of one outer side panel of the two outer side panels and an outer side panel extending from each top edge of the one of the inner side panels, wherein each inner side panel comprises:
a central portion;
a corner portion extending from each side of the central portion; and
an inner end portion extending from a side of each of the corner portions.

2. A blank in accordance with claim 1, further comprising a rollover panel extending between each outer side panel of the two outer side panels and an adjacent inner side panel of the two inner side panels.

3. A blank in accordance with claim 2, wherein a notch is defined at each end of each rollover panel, the notch formed between an inner end panel and an adjacent inner end portion.

4. A blank in accordance with claim 1, further comprising a pair of tabs extending from each top edge of one outer side panel of the two outer side panels.

5. A blank in accordance with claim 1, wherein the bottom panel comprises a plurality of slots configured to receive stacking tabs of a formed container.

6. A blank in accordance with claim 1, wherein the bottom panel comprises a plurality of slots configured to receive stacking tabs of a formed container.

7. A container formed from a blank of sheet material, the container comprising:
a bottom wall;
a pair of opposing end walls coupled to the bottom wall; and
a pair of opposing side walls coupled to the bottom wall;
four corner walls, each corner wall of the four corner walls coupled between one of the end walls and an adjacent one of the side walls; and
a stacking aid portion which overhangs away from an inner portion of the container from one of the corner walls.

8. A container in accordance with claim 7, further comprising a pair of stacking tabs extending from each side wall.

9. A container in accordance with claim 7, wherein the corner wall includes three layers.

10. A container in accordance with claim 9, wherein an adjacent wall to the corner wall includes three layers.

11. A container in accordance with claim 7, further comprising a plurality of slots defined in the bottom wall.

12. A container in accordance with claim 11, wherein said plurality of slots are configured to receive stacking tabs from a second container.

13. A container in accordance with claim 7, wherein a portion of an inner cavity is covered by overhanging portions.

14. A container in accordance with claim 7, wherein the inner rear end panel includes a connector between stacking tabs.

15. A container in accordance with claim 7, wherein the container includes a plurality of miter panels.

16. A container in accordance with claim 15, wherein the miter panels are coupled to angled edges the bottom panel and/or to corner panels.

17. A container in accordance with claim 16, wherein miter panels form reinforcing corner assemblies and angled edges connect side panels and to front and rear panels and respectively with a straight and non-angled edges.

18. A method of forming a container from a blank of sheet material, the blank including a bottom panel, two opposing end panels, each end panel extending from an end edge of the bottom panel, two opposing outer side panels, each outer side panel extending from a side edge of the bottom panel, an inner side panel extending from each top edge of one outer side panel of the two outer side panels, each inner side panel including a central portion, a corner portion extending from each side of the central portion, an inner end portion extending from a side of each of the corner portions, and the central portion and between each inner end portion and an adjacent corner portion, the method comprising:
rotating the outer side panels towards the bottom panel such that the outer side panels are substantially perpendicular to the bottom panel;
rotating the inner side panels towards the bottom panel such that the inner side panels are substantially parallel to the outer side panels, wherein the central portions of each inner side panel and the outer side panels form a pair of opposing side walls;
rotating the corner panels and rotating the corner portions of the inner side panels to form four corner walls;
rotating the inner end panels and rotating the inner end portions such that each inner end panel is in a face-to-face relationship with a respective inner end portion to form an inner end assembly;
rotating the end panels toward the bottom panel such that each end panel is substantially perpendicular to the bottom panel and positioned adjacent a pair of the inner end assemblies to facilitate forming one of a pair of opposing end walls.

19. A method in accordance with claim 18, further comprising folding a pair of tabs extending from each outer side panel toward the bottom panel to form a pair of stacking tabs on the opposing side walls.

20. A method in accordance with claim 18, wherein rotating the corner portions of the inner side panels comprises rotating the corner portions furthest from the central portion.

21. A method in accordance with claim 18, wherein rotating the inner end portions of the inner side panels comprises rotating the corner portions furthest from the central portion.

22. A method in accordance with claim 18, further comprising tearing away a portion of the end panels to reveal an inner portion of the container.

23. A blank of sheet material for forming a polygonal container, the blank comprising:
a bottom panel;
two opposing end panels, each end panel extending from an end edge of the bottom panel;
two opposing outer side panels, each outer side panel extending from a side edge of the bottom panel;
an inner side panel extending from each top edge of one outer side panel of the two outer side panels and a second inner side panel extending from each top edge of one of the inner side panels, wherein each inner side panel comprises:
a central portion;
a corner portion extending from each side of the central portion;
an inner end portion extending from a side of each of the corner portions; and
a rollover panel extending between each outer side panel of the two outer side panels and an adjacent inner side panel of the two inner side panels.
